(19) United States
(12) Patent Application Publication
(10) Pub. No.: US 2007/0153683 A1
(43) Pub. Date: Jul. 5, 2007

(54) Traffic rate control in a network

(76) Inventor: Gary L. McAlpine, Banks, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/354,624

(22) Filed: Feb. 14, 2006

Related U.S. Application Data
(63) Continuation-in-part of application No. 11/322,961, filed on Dec. 30, 2005, now abandoned.

(51) Int. Cl. H04L 12/26; H04J 3/14

(52) U.S. Cl. 370/229; 370/249

(57) ABSTRACT

A system and method for controlling a rate of transmitting data packets into a subnet path by generating at an ingress point to the subnet a rate control signal based on a congestion level feedback signal received from the path and transmitting data packets from the ingress point into the subnet path at the rate based on the rate control signal.

This application is a continuation-in-part of application Ser. No. 11/322,961, titled Traffic Rate Control in a Network, filed Dec. 30, 2005. Additionally, this application is related to patent application Ser. No. 11/114,641 filed on Apr. 25, 2005, titled Congestion Control in a Network.

### TECHNICAL FIELD

The invention relates to data communication. In particular, the invention relates to gathering and providing control information that can be used by a packet switching device at the edge of a layer 2 sub-network (“subnet”) and dynamically controlling the rate of data traffic transmitted to the subnet based thereon.

### BACKGROUND

Although Ethernet is typically used as a local area network (LAN) technology, there is interest in using Ethernet in cluster and blade system interconnects and Storage Area Networks (SAN) as well. (Reference herein to “Ethernet” encompasses the standards for CSMA/CD (Ethernet) based LANs, including the standards defined in the IEEE802.3™-2002, Part 3 Carrier sense multiple access with collision detection (CSMA/CD) access method and physical layer specification, as well other related standards, study groups, projects, and task forces under IEEE 802, including IEEE 802.1D-2004 on Media Access Control (MAC) Bridges). Unfortunately, current Ethernet congestion control support, such as dropping packets, may result in periods of inactivity due to Upper Layer Protocol (ULP) timeouts, which can negatively impact cluster or blade system performance. (The term packet is used herein to mean a unit of information comprising a header, data and trailer, that can be carried across a communication medium, for example, a wire or radio in a computer or telecommunications network. A packet may be referred to as a datagram, cell, or frame. These terms can be used interchangeably with the term packet without departing from the invention).

In the prior art, congestion management (CM) may be implemented in the transport and/or network layers of protocol stacks, applied at the granularity of a transport layer connection or traffic flow (“flow”), rather than at the subnet level for switched Ethernet interconnects. Since CM has historically been viewed as a ULP function from the Ethernet perspective, Ethernet switch technology has evolved to enable layer 2 participation by the use of various Random Early (packet) Discard (RED) algorithms to signal congestion to the ULP CM. Implementing subnet level CM with scalable topologies for Ethernet based SANs, clusters, switching fabrics, and blade system interconnects is a challenge because established standards cannot be easily modified while remaining backward compatible and interoperable, Ethernet is a connectionless oriented protocol (with no notion of specific connections or flows), existing subnet level feedback mechanisms are inadequate, and a subnet typically is shared by many aggregates of flows, each of which may include a diverse range of flows with diverse requirements that are not visible at that layer but must be adequately supported by CM.

### BRIEF DESCRIPTION OF THE DRAWINGS

The invention is illustrated in the accompanying figures, in which:

FIG. 1 is a block diagram of a node in accordance with an embodiment of the invention.

FIG. 2 is a diagram of an example packet format as may be used to transmit layer 2 congestion information in an embodiment of the invention.

FIG. 3 is a sub-network diagram in which an embodiment of the invention may be used.

FIG. 4 is a block diagram of a subnet path analysis in accordance with an embodiment of the invention.

FIG. 5 is a graph of a mathematical function in accordance with an embodiment of the invention.

### DETAILED DESCRIPTION

The invention utilizes Ethernet-based layer 2, or subnet level, congestion management (CM) mechanisms, implemented in hardware and/or software, which operate with existing upper layer (layer 3 or higher) CM mechanisms and layer 1, or link layer, flow control mechanisms. In one embodiment of the invention, a Path Rate Control (PRC) mechanism (simply, “PRC”) is supported by a layer 2 control protocol (L2CP) for finding and establishing a path among a plurality of routes in a switched sub-network, and collecting layer 2 path information. The path information is used by PRC to dynamically control the flow of traffic at the ingress of a layer 2 subnet, such as a switched interconnect. (A node, at a layer 2 endpoint, or edge of a subnet, that receives data traffic from higher layers and transmits the data traffic into a subnet is an ingress, or ingress node, of the subnet, whereas an endpoint node that receives data traffic from the subnet for processing or forwarding to another subnet is an egress node of the subnet).

An Ethernet subnet, for example, within a datacenter network, may interconnect a set of equipment, and/or blades in chassis or racks, into a single system that provides services to both internal clients (within the datacenter) and external clients (outside the datacenter). In such a system, each layer 2 subnet may switch a wide variety of network traffic, as well as local storage and cluster communications. In one embodiment of the invention, a Path Rate Control Interface (PRCI) on or associated with each node or blade interface into or out of the subnet effectively creates a shell around the layer 2 subnet. Inside the shell, the congestion mechanisms provide congestion feedback to the edges of the subnet and enable regulation of traffic flow into the subnet. In one embodiment, traffic entering the subnet is dynamically regulated so as to avoid overloading the points where traffic converges, thereby avoiding the need to drop packets while maintaining high throughput efficiency. In addition, regulation of the traffic at the endpoints, or edges, of the subnet may cause queues above layer 2 (e.g., flow queues) to get backlogged, causing backpressure in the upper layers of the stack. This backpressure may be used to trigger upper layer congestion control mechanisms, without dropping packets within the layer 2 subnet.

Path Rate Control Interface

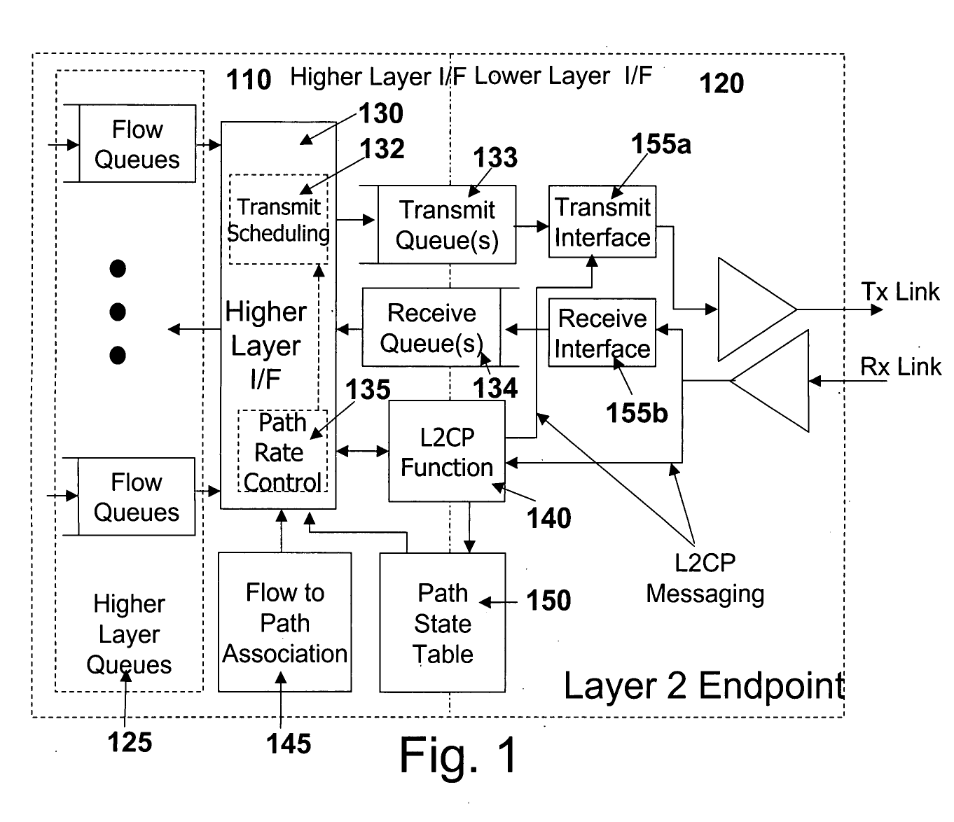

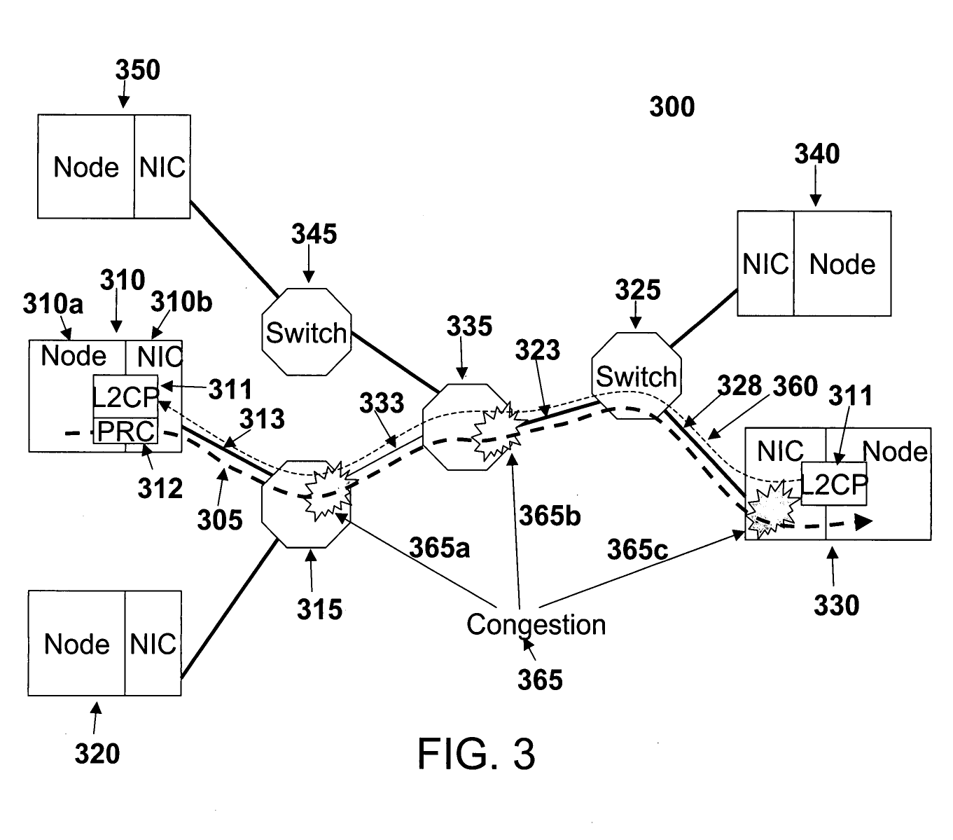

With reference to FIG. 1, in one embodiment of the invention, a Path Rate Control Interface is implemented between the layer 2 components (120) and higher layer (e.g. layers above layer 2) components (110) in a node. The PRCI comprises a Layer 2 Control Protocol (L2CP) function module 140 for generating and receiving L2CP messages and for maintaining path state information, a path state table 150 for interfacing path state information to a higher layer interface 130, and a path rate control (PRC) function module 135 that supports dynamic scheduling of higher layer flows or flow bundles from higher layer transmit queues 125 into the lower layer transmit queue(s) 133 based on path specific congestion and state information. Note that the PRC function does not control the rate of data traffic. Rather, it provides information that can be used by a transmit scheduler 132 for dynamically rate controlling traffic to the layer 2 subnet. One embodiment of the PRCI implements the layer 2 functionality primarily in hardware and the higher layer functionality in a combination of hardware, firmware, and/or driver level software. The higher layer functionality may utilize existing address translation tables 145 to associate flows with paths. (A path may be defined by a destination MAC address from a given source MAC perspective. A unique communication path exists between any two nodes at the edges of the subnetwork. For example, with reference to FIG. 3, a unique communication path exists between nodes 310 and 330, by way of link 313, switch 315, link 333, switch 335, link 323, switch 325 and link 328.)

The L2CP function module 140 automatically discovers and selects a unique path from a number of routes through the subnet to a particular destination endpoint and supplies congestion and rate control information about the path to the PRC function module 135 through the path state table 150. This information enables module 135 to supply dynamic rate control information to transmit scheduler 132 for congestion control at the subnet level. Transmit scheduler 132 may selectively use the dynamic rate control information to optimize the scheduling of higher layer flows or flow bundles from queues 125 into lower layer transmit queues 133 in order to avoid oversubscription of lower layer resources. Rate control and flow optimization into the subnet enables using buffers above layer 2 (which in the aggregate are generally much larger than lower layer buffers) to absorb large bursts of traffic, insulating the layer 2 components 120 within node 110, but also nodes in the subnet, e.g., nodes 315, 325, 335, from much of that burden and reducing layer 2 buffer sizes.

This partitioning further provides for node implementations that dedicate one or more processing cores (in multi-core nodes) to handling the input and output for the set of cores used for application processing (e.g., an asymmetric multi-processor (AMP) mode of operation). In this mode of operation, most of the functionality between the higher layer queues and the layer 2 transmit and receive hardware can be implemented in software that runs on the dedicated I/O core(s). For single processor or symmetric multi-processor (SMP) systems running general purpose operating systems (such as Microsoft Windows™ or Linux, available under the GNU General Public License from the Free Software Foundation, Inc.), the transmit scheduler 132, path rate control module 135, and L2CP module 140 may be implemented in a network interface card (NIC) or chipset level hardware/firmware. Such an embodiment may benefit from an additional path oriented level of queuing to the transmit scheduler from the higher layers.

Layer 2 Control Protocol

In one embodiment of the invention, a layer 2 control protocol (L2CP) provides control information about each individual path through a layer 2 subnetwork (“layer 2 subnet” or, simply, “subnet”) to higher layer functions, such as a path rate control function (PRC). L2CP, for example, supports the functionality for discovering and selecting path routes, collecting path and congestion information from the layer 2 subnet, and conveying such information to functions at the edges of the subnet. L2CP is, advantageously, a protocol that may be inserted into a standard network protocol stack between the network and link layers, presenting minimal disruption to any existing standards and providing interoperability with existing implementations.

Implementation of the protocol in accordance with an embodiment of the invention requires no changes to operating systems or upper layer protocols in the protocol stack or changes to existing link layer Media Access Control (MAC) packet formats, or packet header definitions. An implementation of the protocol involves changes to the interface between the upper protocol layers and the lower protocol layers (e.g. Network Interface Cards (NICs) and driver level program code), support for L2CP in the switches, and definition of a new L2CP control packet format. However, it is contemplated that the protocol can be implemented such that layer 2 components that are L2CP aware interoperate with components that are not.

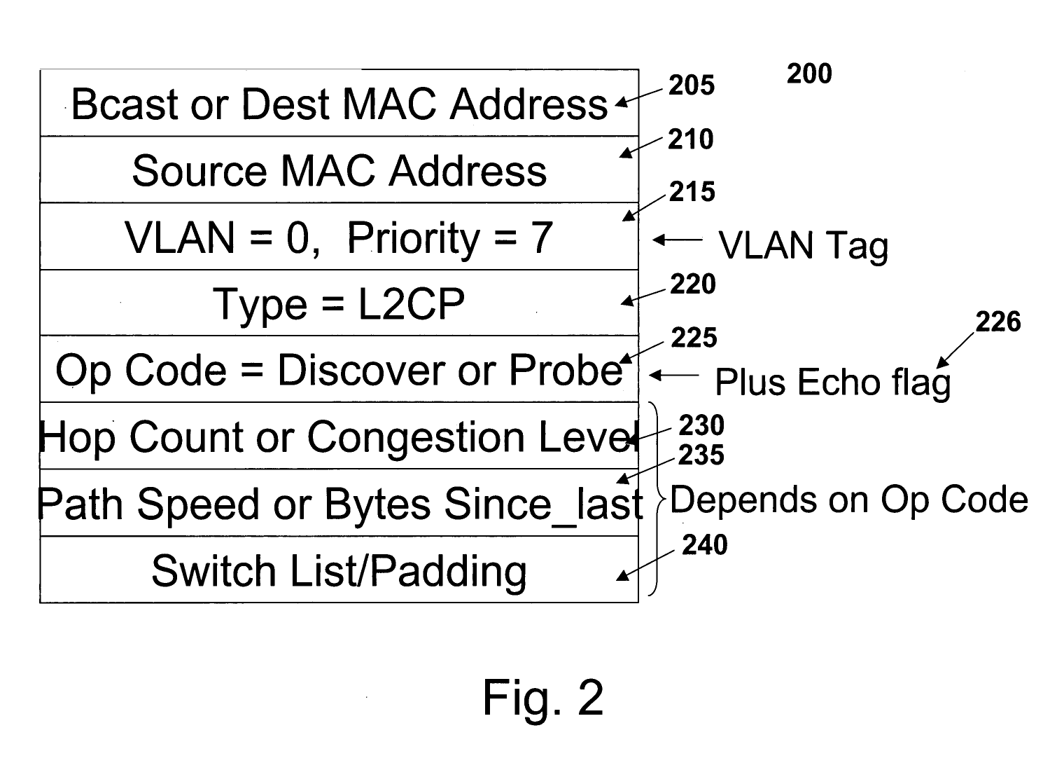

FIG. 2 depicts the format of L2CP messages (“packets”) 200 in accordance with an embodiment of the invention. A broadcast or destination Media Access Control (MAC) address field 205 identifies the destination of the message. A source MAC address field 210 identifies the source of the message. A Virtual Local Area Network (VLAN) tag 215 is used to specify the priority of the message, e.g., Priority=(0.7), but the VLAN identifier (VLAN ID, or VLAN) is set to 0 (or null). A type field 220 indicates an L2CP message. In one embodiment, a new Ethernet type value is used to identify the protocol. An operation code field (Opcode) 225 specifies a type of L2CP message (“discover”, “discover echo”, “probe” or “probe echo”). An echo flag 226, included in an operation code (opcode) field in one embodiment, indicates whether the message is one of the two echo messages. Depending on the value of the opcode field, the next three fields 230, 235 and 240, are interpreted in one of two ways: discover and discover echo messages include hop count, path speed, and switch list fields, while probe and probe echo messages include congestion level, bytes-since-last (probe), and padding fields.

It should be noted that a minimum packet size, e.g., 64 bytes, leaves an amount of padding space in each probe packet. In one embodiment of the invention, this padding space could be used to carry additional congestion or flow control information specific to the functions interfacing to layer 2. For example, a router or line-card blade might include congestion information specific to its external ports.

The L2CP may be implemented to support automatic path and route maintenance. In one embodiment, the protocol initially sequences through three phases: 1) routes-discovery, 2) route-selection/path-discovery, and 3) path-maintenance. The path-maintenance phase continues so long as the subnet topology is stable. Phases 1 & 2 can reoccur periodically or after a topology change, for example, in order to maintain appropriate path tables and switch filter databases (Ethernet switches include a filter database for storage of state and routing information with each entry typically associated with a specific VLAN and destination MAC address). In the same way that switch filter database entries are typically timed out after a sufficient period of inactivity, path table entries and their associated routes may be timed out and automatically re-established, in one embodiment of the invention.

Route Discovery Phase

The L2CP function module 140 operates independently on each layer 2 endpoint. For the routes-discovery phase, and with reference to FIGS. 2 and 3, each endpoint, e.g., 310, 320, 330, 340, 350, transmits a L2CP “broadcast discover” packet (with opcode field 225=“discover”), specifying a well known broadcast MAC address 205 to announce its presence on the subnet 300. As the broadcast discover propagates through the subnet, each switch 315, 325, 335, 345 receives the packet and may use the source MAC address 210 therein to either create or update an entry in its respective filter database. In one embodiment, the first broadcast discover packet a switch receives from a particular endpoint, e.g., endpoint 310, corresponding to the source MAC address (i.e., the source endpoint) causes the switch to create a new entry in its filter database. As one example, a filter database entry can hold information for a number of ports, N, via which to reach a source endpoint (e.g., a normal spanning-tree protocol (STP) port and up to some number of alternative ports, n-1). This allows distributing the set of source/destination paths through the subnet n-1 ways across the set of available routes. (However, it should be understood that the number of alternative routes supported in a given switch is an implementation choice.)

Each switch that the broadcast discover packet traverses adds its identifying information, e.g., a switch ID, MAC address or some other such unique identifying information, to the switch list field 240 in the broadcast discover packet. A switch forwards the broadcast discover packet out all ports except the port via which it was received. Subsequent copies of the broadcast discover packet received at another port of the switch may cause updates to the switch's filter database entry, but then are dropped to prevent broadcast loops and storms. The first broadcast discover packet that reaches an endpoint, e.g., endpoint 330, may be used to create therein a new entry in path state table 150 (see FIG. 1) corresponding to the source endpoint. In this manner, all endpoints in the subnet discover the source endpoint that transmitted the broadcast discover packet is connected to the subnet. If all endpoints send broadcast discover messages (initially and then periodically), all endpoints discover all other endpoints in the subnet and each maintains a current path table entry for each of the others as long as their communications continue to be received.

Route-Select/Path-Discovery Phase

In the route-select/path-discovery phase, path table entries are initialized in response to the first transmission of data traffic to the corresponding destination endpoints (defined, for example, by that destination endpoint's MAC address, as learned from a broadcast discover packet received at the source endpoint from the destination endpoint). In one embodiment of the invention, the source endpoint precedes the first data transmission to a path with a L2CP “unicast discover”, or simply, “discover” packet, to the destination endpoint, specifying the MAC address of the destination endpoint in the destination MAC address field 205. As the discover packet traverses each switch, either the STP route, or one of the alternative routes, is selected for that path and recorded in the filter database maintained by the switch. The route may be selected in any number of ways, for example, by a load distribution/balancing algorithm.

The discover packet is then updated with path discovery information and forwarded to the port for the selected route. Thus, as the discover packet traverses the subnet, it establishes a selected route for the path and collects information about the path. At the destination endpoint, the discover packet is echoed directly back to the source endpoint (with echo flag 226 appropriately set). The path information in the discover echo packet is used to update a path state table entry corresponding to the destination endpoint in a path state table maintained by the source endpoint.

The unicast discover packet is updated at each switch to collect the hop count to the destination endpoint and the speed of the slowest link in the path in the forward direction. This information is maintained in fields 230 and 235, respectively. When the discover echo packet is received at the source endpoint, the L2CP function measures the round trip time (RTT) of the discover packet to derive a minimum one way delay (D_{Tmin}=˜RTT/2). Note that L2CP packets, including discovery packets, may be sent at the highest priority (e.g., field 215=priority 7) to minimize their delay through the subnet. The D_{Tmin}, hop count (N), and path speed (Ps) provide the initial state for that path and are used by the PRC algorithm to calculate rate control information, as discussed in more detail below.

Path-Maintenance Phase

During the path-maintenance phase, L2CP “probe” packets (with opcode field 225=“probe”) are periodically sent through each path to collect congestion level information and deliver it to the path ingress L2CP function 140, where it may be used to update the corresponding path state table entry (which, for example, may be used by the PRC algorithm in controlling the rate of transmission of data traffic to the path). The L2CP “probe” process is illustrated in FIG. 3. Once a path of traffic flow (denoted by reference number 305) is initialized, the L2CP function (depicted as module 140 in FIG. 1, module 311 in FIG. 3) in the path egress endpoint, e.g., endpoint 330, periodically sends a probe packet 360 that traverses the subnet along the same path as the normal forward traffic, but in the opposite direction. In one embodiment, probe packets for a given path are sent at a fraction of the rate of the traffic received at the path egress endpoint 330.

In an alternative embodiment, the L2CP function at the path ingress endpoint, e.g., endpoint 310, periodically inserts probe packets into the forward data traffic stream to collect path congestion information in the forward direction. These probe packets may get updated by any of the switches 315, 335, 325 or the egress endpoint 330 and echoed back to the ingress endpoint 310. This method may be used, for example, where the forward and reverse paths through the subnet are different.

The initial information in each probe packet depends on whether probes are generated from the path ingresses (e.g. forward probes) or the path egresses (e.g. reverse probes). Each forward probe packet initially contains zero in the congestion level field 230 and the number of bytes sent since the last probe in the byte-since-last field 235. Each reverse probe packet initially contains information regarding the congestion level at the egress endpoint that issues the probe packet (specified, for example, as a percent of a receive buffer currently used) and the bytes received at the egress endpoint since the last probe. Regardless of whether probes are sent in the forward or reverse direction, the congestion level fields in a series of probe packets for a given path deliver the congestion level feedback signal to the ingress endpoint L2CP function 311.

As a probe packet passes through each switch in a path through the subnet, if the local congestion level 365 at a switch for the specified path, e.g., congestion 365b at switch 335 or congestion 365a at switch 315, is greater than the congestion level indicated in the probe packet, the switch replaces the congestion level in field 230 of the packet with its local congestion level. Thus, each reverse probe (or forward probe echo) packet received by an ingress endpoint L2CP function indicates the congestion level at the most congested point along the corresponding path. In one embodiment, the congestion level for a path is given by the following:
Cₚₐₜₕ=max{C₁, C₂, . . . , C_{N}}
where 1 to N represent the hops in the path. In one embodiment, C is in the range [0,˜150].

Each probe packet is used to update the corresponding path state in table 150 at the path ingress node 310 to reflect the current congestion level for the path. Although the congestion level could be derived by various methods, in one embodiment of the invention, the percentage of a per-port buffer allotment currently populated at a transmit port in a switch or a receive port of an egress endpoint is measured. (In a buffer sharing switch, the allotment may be the effective per-port buffer size and the percent of the allotment populated may be greater than 100%). This measurement of congestion works well if estimating the level of dispersion needed between packets entering a path in order to compensate for the congestion along the path. The dispersion estimate is directly usable to calculate a stride between packets at the ingress endpoint, which may be more relevant to a transmit scheduler 132 than a rate estimate. Thus, the stride (or minimum time) from the posting of a data packet for transmission to the posting of the next data packet for transmission is calculated by:
stride=max{(Fs_{posted}/Psₚₐₜₕ)*Dmₚₐₜₕ,(Fs_{posted}/Psₚₐₜₕ)}
Where Psₚₐₜₕ=path_speed in bits/second; Fs_{posted}=total # of bit times that will be consumed on a link for the data packet posted; and Dmₚₐₜₕ=the dispersion multiplier required to compensate for the current level of congestion along the path (defined in the sections below). The dispersion multiplier (in range [1, x]) essentially inflates the perceived time the packet will consume on the slowest link in the path when the congestion level is non-zero.

L2CP Messaging and Feedback Control

With reference to FIG. 1, in one embodiment, the L2CP function module 140 performs three basic functions, 1) control, 2) message generation (sending L2CP discover, probe, or corresponding echo, packets), and 3) message reception (receiving L2CP packets). The control function communicates with a higher layer interface 130 to learn when a data packet is posted by transmit scheduler 132 to a transmit queue 133 associated with a path that either has no corresponding entry in path state table 150 or the corresponding entry is not initialized. In one embodiment of the invention, given a limited size table with entries for only the most recently used paths, an indication that no entry exists may indicate this is the first data packet posted for the path since the previous entry was last evicted (in this case, a new entry for that path is placed in the path state table). In either case, a unicast discover message is transmitted via transmit interface 155a over the path to the destination endpoint. As discussed above, the egress L2CP function 140 echoes the discover packet, and when the discover echo packet is received at the ingress L2CP function for that path, the corresponding path state table entry is initialized with the hop count (N), path speed (Ps), and minimum delay (D_{Tmin}).

The message generation function creates or echoes L2CP packets (discover or probe) and sends them to the transmit interface 155a. The message reception function receives L2CP messages via receive interface 155b, extracts the fields from the received messages and passes the information to the control function for updating the corresponding path state table entries in table 150. The message generation function also echoes messages (when required) by first swapping the destination and source MAC addresses 205, 210, setting the echo flag 226, and then forwarding the message to transmit interface 155a.

To control the rate at which reverse probe packets are generated (by the egress L2CP function) for a given path, the time the last probe was sent (Ptₚₐₜₕ) and number of bytes received since the last probe was sent (Bpₚₐₜₕ) are tracked in the corresponding path state table entry (at the egress endpoint of the path). In one embodiment of the invention, two threshold constants (Th_{bytes} and Thₜᵢₘₑ) are used to trigger message generation, one for byte count and one for time. When a data packet is received from a path, the control function uses the encapsulated packet size (Pk_{size}) and current time (t_{now}) for probe generation as follows:
if (((Bpₚₐₜₕ+Pk_{size})>=Th_{bytes}) or ((t_{now}−Ptₚₐₜₕ)>=Thₜᵢₘₑ))
{Generate a probe message and set congestion level=receiver congestion level;
Set bytes_since_last=(Bpₚₐₜₕ+Pk_{size});
Update path state fields Ptₚₐₜₕ=t_{now}, and Bpₚₐₜₕ=0};
else {Update path state field Bpₚₐₜₕ=Bpₚₐₜₕ+Pk_{size}}
In an embodiment using forward probing, the rate at which forward probe packets are generated (by the ingress L2CP function) for a given path uses the same procedure with the following differences: 1) Ptₚₐₜₕ and Bpₚₐₜₕ are tracked in the path state table at the ingress endpoint of the path; 2) Bpₚₐₜₕ tracks the bytes sent since the last probe; 3) Pk_{size} is the size of the current encapsulated data packet being sent; and 4) the congestion level field in the probe packets is set to zero.

Controlling the probe rate in this way, distributes the total bandwidth consumed by probe messaging across the subnet roughly proportional to the distribution of data traffic. The two thresholds can be set to control the rate of probe messaging. In one embodiment of the invention, these thresholds control the maximum bandwidth consumed by probe messaging (generally between 1% and 1.5% of the total workload). The procedure establishes an upper limit on the rate of feedback when traffic is heavy, while at the same time ensures a minimum amount of feedback when data traffic is light or frames are dropped.

A data in-flight (Iₚₐₜₕ) field in the (ingress) state table entry for each path is used to track an estimate of the number of total data bytes in-flight between the ingress and egress of the corresponding path. The Iₚₐₜₕ field for a given path is updated in the positive direction by the Path Rate Control function 135 each time a data packet for the corresponding path is posted to a Transmit Queue 133. It is update in the positive direction as follows:
Iₚₐₜₕ=Iₚₐₜₕ+Fs_{posted}
The Iₚₐₜₕ field is also updated in the negative direction by the L2CP function 140 each time a probe message is received at the path ingress. It is updated using the bytes-since-last field 235 from the probe as follows to ensure it does not go negative:
Iₚₐₜₕ=max{(Iₚₐₜₕ−bytes_since_last), 0}
The Iₚₐₜₕ field may be utilized by the Transmit Scheduler 132 to limit the amount of data in-flight in a given path pipeline at one time.

In a connectionless oriented network there are no acknowledgements to ensure the layer 2 endpoints (ingress and egress) stay synchronized. Thus, in one embodiment of the invention, to ensure transmission to a path does not stall waiting for a probe that is lost or will not happen due to traffic loss, Iₚₐₜₕ is only allowed to be valid for a finite amount of time. A maximum time in-flight (Tiₘₐₓ) is used to limit the time a given Iₚₐₜₕ value is valid. Tiₘₐₓ may be calculated as follows:
Tiₘₐₓ=2*Pₘₐₓ*Dmₚₐₜₕ/Psₚₐₜₕ
where Pₘₐₓ is an estimate of the maximum number of bits to fill the path pipeline (described below); Dmₚₐₜₕ is the current dispersion multiplier for the path; and Psₚₐₜₕ is the speed of the slowest link in the path in bits per second.

In this manner, if there has been no traffic flow into a path for at least this amount of time, all previous packets are considered to have traversed the subnet and Iₚₐₜₕ is set to zero.

Path Pipeline Depth Estimation

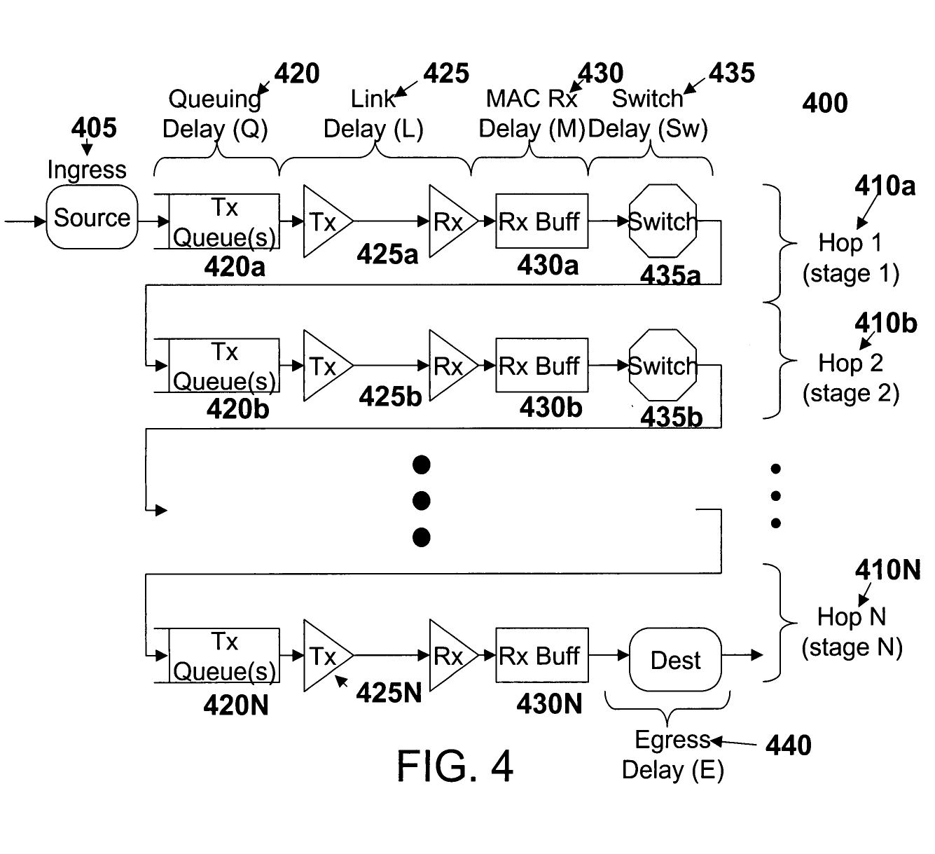

The Path Rate Control function embodied in module 135 uses a generalized model (shown in FIG. 4) that treats each path in a subnet as a pipeline wherein each hop is a “stage” in the pipeline. The model assumes a path pipeline traverses 0 to N-1 switches. The switch model assumed is a generalized output queued switch, which is the basic model emulated by most (if not all) Ethernet switches. With reference to FIG. 4, each stage 410a, 410b . . . 410N in the pipeline 400 comprises a series of fixed and variable time delays. A stage may be viewed as comprising a variable transmit queuing delay (Q) 420, a fixed link delay (L) 425, a variable MAC receive delay (M) 430, and a fixed switch (Sw) 435 or egress endpoint (E) delay 440. Although some Ethernet switches implement cut-through MACs (with minimized fixed delays), this generalized model assumes the MAC receive delay may be variable by frame size because most MACs store each complete received frame before forwarding it. Although there may be other variable delays in the pipeline, this generalized embodiment accounts for such variations by assuming they are part of the queuing delays 420. The fixed link delays are each dependent on the link length, type of link, and transceiver delay, but each represents a fixed delay within its corresponding stage. The total delay (DT) for a given path can be calculated as follows:

$${D}_{T} = ( {\sum }_{i = 1}^{N} {Q}_{i} + {L}_{i} + {M}_{i} ) + {\sum }_{i = 1}^{N - 1} {Sw}_{i} + E$$

Where N=number of hops in the path and T=total for the path.

One of the points where congestion may occur along a path is where multiple packet streams multiplex into the link transmitters (425a, 425b . . . 425N). Congestion at these points results in backlogs in the transmit queues (Tx Queues 420a, 420b . . . 420N). In the absence of congestion, the total variable queuing delay is nil (Q_{T}=˜0) and the minimum number of bits required in-flight between the endpoints (ingress and egress) to fill the pipeline can be estimated for a path by (Pₘᵢₙ=D_{Tmin}*Ps) given the minimum one-way delay (D_{Tmin}) and the path speed (Ps) from the state table entry for the path. (Note: D_{Tmin} accounts for the total MAC receive delay (M_{T}) assuming the minimum Ethernet frame size (Fsₘᵢₙ) because the L2CP discover packet used to measure RTT is a minimum sized Ethernet frame.)

Given Pₘᵢₙ, the maximum number of bits required to fill a path pipeline in the absence of congestion (Pₘₐₓ) may be estimated by assuming a stream of maximum sized frames (Fsₘₐₓ) and adding the additional MAC receive delay for the number of stages (e.g. hops or N) in the path:
Pₘₐₓ=Pₘᵢₙ+N*(Fsₘₐₓ−Fsₘᵢₙ)
It should be noted that a number of bits greater than Pₘₐₓ bits may be required to keep the pipeline filled during congestion, depending on the maximum rate at which the ingress 405 transmits.

In one embodiment of the invention, for the ingress to sustain up to 10 gigabits per second (Gbps), approximately four additional maximum size frames need to be buffered per hop. Thus, for ingress transmit speeds of up to 10 Gbps, Pₘₐₓ may be estimated by the following equation:
Pₘₐₓ=Pₘᵢₙ+N*(F*Fsₘₐₓ−Fsₘᵢₙ)
Where F is in the range of [0,˜5] for source speeds in the range of [<2, 10] Gbps.

Ingress Rate Control

For ingress rate control of traffic into a subnet by a source endpoint, Pₘₐₓ is calculated for each path and may be used to limit the maximum data allowed in-flight between the path ingress (source endpoint) and path egress (destination endpoint) at any given time. In addition, the maximum rate of transmission into each path may be controlled by dynamically varying the time (e.g. stride) between packets being posted for transmission. Two signals provide the primary control for the transmission rate into a path: 1) the congestion level feedback signal (Cₚₐₜₕ) and 2) the rate control signal (Rₚₐₜₕ). In one embodiment of the invention, Rₚₐₜₕ tracks Cₚₐₜₕ by a compound non-linear function. The Cₚₐₜₕ signal for each path is provided by the Congestion Level field 230 in the stream of probe (or probe echo) packets received at the path ingress L2CP function. The Rₚₐₜₕ signal gets updated in the path state table entry for the path as a function of the difference between the previous Rₚₐₜₕ (at probe time t-1) and the new Cₚₐₜₕ (at probe time t) each time an L2CP probe packet is received (e.g. Rₜ=f(Cₜ−Rₜ₋₁)).

In one embodiment, a compound non-linear function may control the conversion of the Cₚₐₜₕ signal to the Rₚₐₜₕ signal so as to exaggerate its response to sharp increases in congestion, quickly re-align with Cₚₐₜₕ after the sharp increase is stifled, and then track Cₚₐₜₕ in a smoothed manner around equilibrium (using two references to control the rate of increase (Rf_{inc}) and decrease (Rf_{dec}) of the Rₚₐₜₕ signal). Thus, the Rₚₐₜₕ signal may be updated as follows each time a probe is received:
Rₜ=Rₜ₋₁+{if ((Cₜ−Rₜ₋₁)>0) then (Cₜ−Rₜ₋₁)**2/Rf_{inc};
else if ((Cₜ−Rₜ₋₁)<Rf_{dec}) then (Cₜ−Rₜ₋₁);
else (Cₜ−Rₜ₋₁)**2/Rf_{dec}}
or, expressed differently:
if ((Cₜ−Rₜ₋₁)>0), then Rₜ=Rₜ₋₁+(Cₜ−Rₜ₋₁)**2/Rf_{inc};
else if ((Cₜ−Rₜ₋₁)<Rf_{dec}), then Rₜ=Rₜ₋₁+(Cₜ−Rₜ₋₁);
else Rₜ=Rₜ₋₁+(Cₜ−Rₜ₋₁)**2/Rf_{dec}
Where Cₜ=congestion level feedback signal (at probe time t), in range [0, ˜150];
Rₜ=primary rate control signal (at probe time t), in range [1, f(Cₜ−Rₜ₋₁)];
Rf_{inc}=reference for increases, in range [˜10, ˜50]; and
Rf_{dec}=reference for decreases, in range [˜−50, ˜−100].

The function uses the difference between the current congestion level feedback signal (Cₜ) and the previous rate control signal (Rₜ₋₁) level to update the current rate control signal (Rₜ) in the path state table entry for the corresponding path. If the difference is positive, then the rate control signal is increased non-linearly to slow the rate of transmission to the path (a difference greater than Rf_{inc} causes a non-linear response greater than the difference in order to stifle a sharp congestion increase). If the difference is more negative than the reference Rf_{dec}, then the rate control signal is linearly decreased by the difference in order to re-align the rate with the congestion level after a sharp congestion increase is stifled. Finally, if the difference is less negative or equal to Rf_{dec}, then the rate control signal is decreased non-linearly to allow an increase in the transmission rate to the path. While the differences stay between Rf_{inc} and Rf_{dec}, the adjustments to the rate are less than the congestion changes, which has a smoothing effect on the Rₚₐₜₕ signal and stabilizes it around equilibrium.

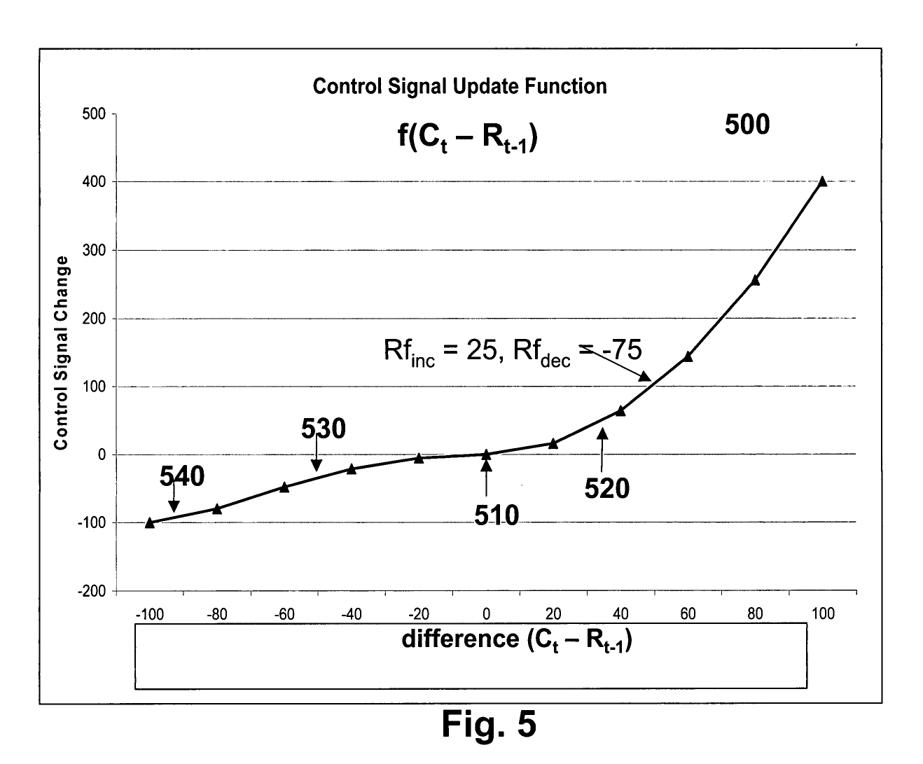

FIG. 5 shows a graph 500 of the function f(Cₜ−Rₜ₋₁) for Rf_{inc}=25 and Rf_{dec}=−75. Curves for the function f(Cₜ−Rₜ₋₁) are non linear with a flat region 510 where the difference between Cₜ and Rₜ₋₁ is near zero. This region provides hysteresis around the point of equilibrium which causes Rₚₐₜₕ to remain stable once it reacts to a sharp increase in congestion and re-aligns after the increase is stifled. Rf_{inc} controls the slope of the curve to the right of zero difference 520 and Rf_{dec} controls the slope to the left of zero difference 530. Forcing the curve to the left to go linear 540 (the middle term in the compound function) with negative differences of greater magnitude than Rf_{dec} provides quick re-alignment after a sharp increase and makes the control loop significantly more stable.

When a packet is posted to the layer 2 transmit queues 133, the resulting frame size (Fs_{posted}) and the path speed (Psₚₐₜₕ) are used to calculate the frame transmission time at the path speed. The frame transmission time is used as the minimum time before the path is eligible for posting the next packet for transmission. The control signal for the corresponding path (Rₚₐₜₕ) is used to calculate a dispersion multiplier (Dmₚₐₜₕ) that may inflate this minimum time (or stride) between packets as required to regulate the rate of transmission in response to congestion. Each time a packet is posted to Transmit Queues 133 for transmission, the total data in-flight (Iₚₐₜₕ ) and the next eligible time for posting a packet (Etₚₐₜₕ) are updated in the path state table as follows:
Dmₚₐₜₕ=Rₚₐₜₕ*S
stride=max{(Fs_{posted}/Psₚₐₜₕ)*Dmₚₐₜₕ, (Fs_{posted}/Psₚₐₜₕ)}
Etₚₐₜₕ=time_posted+stride
Iₚₐₜₕ=Iₚₐₜₕ+Fs_{posted}
Where, in one embodiment, Fs=the frame size (in bits) that results from the packet posted, including the header, padding, FCS, and link overhead; and S=a scaling factor in the range [˜0.25,˜1.0].

S is a constant used to scale how aggressively Rₚₐₜₕ controls transfer rates. The lower the value of S, the less aggressive the rate control and the deeper the mean queuing depths range in the switches during congestion. With S set to 0.25, 0.5, or 1.0, buffer depths at a saturated link average ˜80%, ˜50%, or ˜20% of the per-port allotment, respectively. In one embodiment, Rₚₐₜₕ and Iₚₐₜₕ are updated in the path state by the L2CP function 140 each time a probe message is received for the corresponding path. Etpath and Iₚₐₜₕ are updated by the Path Rate Control function 135 each time a packet is posted for transmission into the corresponding path. Etₚₐₜₕ and Iₚₐₜₕ can be utilized by a transmit scheduler 132 to qualify traffic for scheduling to the transmit queues 133. By doing so, layer 2 subnet ingress traffic rates can be dynamically regulated so as to avoid overloading switch and egress buffers, maintain efficient interconnect throughput, and avoid the need to drop packets in the subnet.

Elements of embodiments of the present invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or other type of machine-readable media suitable for storing electronic instructions. For example, embodiments of the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

It should be appreciated that reference throughout this specification to “one embodiment” or “an embodiment” means that a particular feature, structure or characteristic described in connection with the embodiment is included in at least one embodiment of the present invention. These references are not necessarily all referring to the same embodiment. Furthermore, the particular features, structures or characteristics may be combined as suitable in one or more embodiments of the invention.

What is claimed is:

1. A method for controlling a rate of transmitting data packets into a subnet path:
generating at an ingress point to the subnet a rate control signal based on a congestion level feedback signal received from the path; and
transmitting data packets from the ingress point into the subnet path at a rate based on the rate control signal.

2. The method of claim 1, further comprising:
receiving periodically the congestion level feedback signal from the path; and
generating a current rate control signal based on a most recently received congestion level feedback signal (hereinafter “the current congestion level feedback signal”) and the rate control signal (hereinafter “the previous rate control signal”).

3. The method of claim 2, wherein the congestion level feedback signal at a given time interval is based on a maximum level of congestion at any stage in the subnet path during that time interval.

4. The method of claim 2, wherein the current rate control signal is generated as a function of the difference between the previous rate control signal and the current congestion level feedback signal.

5. The method of claim 2, wherein the current rate control signal is increased non-linearly if the current congestion level feedback signal is greater than the previous rate control signal.

6. The method of claim 2, wherein the current rate control signal is decreased linearly based on a negative difference between the current congestion feedback control signal and the previous rate control signal if the difference exceeds a negative threshold.

7. The method of claim 2, wherein the current rate control signal is decreased non-linearly if the current congestion level feedback signal less the previous rate control signal is negative but does not exceed a threshold in the negative direction.

8. The method of claim 1, further comprising determining a next eligible time for transmitting a packet queued for transmission from the ingress point into the subnet path based on a transmission time for the packet.

9. The method of claim 8, further comprising generating the transmission time for the packet based on a quotient of a size of the packet (hereinafter “packet size”) and a speed of a slowest link in the path (hereinafter “path speed”).

10. The method of claim 9, wherein the next eligible time for transmitting the packet is determined based on a sum of a time the packet was queued for transmission and the quotient.

11. The method of claim 10, wherein the next eligible time for transmitting the packet is alternately determined based on a sum of the time the packet was queued for transmission and a product of the quotient, the rate control signal, and a scaling factor.

12. The method of claim 11, further comprising transmitting the packet on or after the larger of the determined and alternately a minimum next eligible time.

13. An apparatus to control a rate at which to transmit data packets, comprising:
a congestion messaging module to receive a congestion feedback signal from a subnet path;
a path state table coupled to the congestion messaging module and in which to store a state of the subnet path based on the congestion feedback signal;
a path rate control module coupled to the congestion messaging module and the path state table to generate a rate control signal based on input from the state table and congestion messaging module; and
a transmit scheduler coupled to the path rate control module to control the transmission of data packets into the subnet path based on the rate control signal.

14. The apparatus of claim 13, further comprising:
an address translation table, the address translation table to associate a data packet flow or flow bundle with a subnet path; and wherein the transmit scheduler to control the transmission of data packets belonging to the flow or flow bundle into the subnet path.

15. The apparatus of claim 13, further comprising a plurality of flow queues in which to store the flows or flow bundles to be scheduled for transmission into the subnet path.

16. The apparatus of claim 13, wherein:
the congestion messaging module to receive periodic congestion level feedback signals from the subnet path;
the path rate control module to generate a current rate control signal based on the latest congestion level feedback signal and the rate control signal; and
the transmit scheduler to control the transmission of data packets into the subnet path based on the current rate control signal.

17. The apparatus of claim 13, wherein the path rate control module to generate the current rate control signal as a function of the difference between the rate control signal and the latest congestion level feedback signal

18. The apparatus of claim 13, wherein the transmit scheduler to determine a next eligible time to transmit a packet queued for transmission into the subnet path based on a transmission time for the packet.

19. A system, comprising:
at least one processing core to process an application program;
another processing core coupled to the application processing core(s) to process data input and output for the application processing core(s), the I/O processing core comprising:
a congestion messaging module to receive a congestion feedback signal from a subnet path;
a path state table coupled to the congestion messaging module and in which to store a state of the subnet path based on the congestion feedback signal;
a path rate control module coupled to the congestion messaging module and the path state table to generate a rate control signal based on input from the state table and congestion messaging module; and
a transmit scheduler coupled to the path rate control module to control the transmission of the output data in packets into the subnet path based on the rate control signal; and
a transmitter coupled to the transmit scheduler to transmit the data packets.

20. The system of claim 19, wherein:
the congestion messaging module to receive periodic congestion level feedback signals from the path;
the path rate control module to generate a current rate control signal based on the latest congestion level feedback signal and the rate control signal; and
the transmit scheduler to control the transmission of data packets into the subnet path based on the current rate control signal.

21. The system of claim 20, wherein the path rate control module to generate the current rate control signal as a function of the difference between the rate control signal and the latest congestion level feedback signal.

22. An article of manufacture, comprising:
an electronically accessible medium including instructions for controlling a rate of transmitting data packets into a subnet path that when executed by a network interface card, cause the card to:
generate at an ingress point to the subnet a rate control signal based on a congestion level feedback signal received from the path; and
transmit data packets from the ingress point into the subnet path at a rate based on the rate control signal.

23. The article of manufacture of claim 22, further comprising instructions that when executed by the network interface card, cause the card to:
receive periodically the congestion level feedback signal from the path; and
generate a current rate control signal based on a most recently received congestion level feedback signal and the rate control signal.

24. The article of manufacture of claim 23, wherein the instructions, when executed by the network interface card, cause the card to generate the current rate control signal as a function of the difference between the rate control signal and the most recently received congestion level feedback signal.

25. The article of manufacture of claim 23, wherein the current rate control signal is increased non-linearly if the current congestion level feedback signal is greater than the previous rate control signal, decreased linearly based on the difference between the current congestion feedback control signal and the previous rate control signal if the current congestion level feedback signal less the previous rate control signal is negative and exceeds a threshold in the negative direction, and decreased non-linearly if the current congestion level feedback signal less the previous rate control signal is negative but does not exceed a threshold in the negative direction.
